(19) United States
(12) Patent Application Publication
(10) Pub. No.: US 2013/0076487 A1
(43) Pub. Date: Mar. 28, 2013

(54) DEVICE AND A METHOD FOR THE IDENTIFICATION OF PERSONS

(71) Applicant: Christian Evers, Kirchheim (DE)

(72) Inventor: Christian Evers, Kirchheim (DE)

(73) Assignee: Rohde & Schwarz GmbH & Co. KG, Munich (DE)

(21) Appl. No.: 13/695,253

(22) PCT Filed: Mar. 22, 2011
(86) PCT No.: PCT/EP11/54359

§ 371 Date: Oct. 29, 2012

(30) Foreign Application Priority Data
Mar. 31, 2010 (DE) 10 2010 013 580.1

(51) Int. Cl. G06F 21/32

(52) U.S. Cl. CPC G06F 21/32
USPC 340/5.83

(57) ABSTRACT

A person-identification system which includes a scanner unit, which scans a person to be identified by an electromagnetic radiation. The electromagnetic radiation provides a wavelength in the millimeter range and/or centimeter range. The scanner unit prepares a three-dimensional image of body geometries of the person to be identified as test data in a storage unit. The person-identification system further provides a processing unit which processes the test data and extracts biometric features necessary for the identification and compares these with biometric features which are stored in at least one further storage unit.

### CROSS-REFERENCE TO RELATED APPLICATION

The present application is a national phase application of PCT Application No. PCT/EP2011/054359, filed on Mar. 22, 2011, and claims priority to German Application No. DE 10 2010 013 580.1, filed on Mar. 31, 2010, the entire contents of which are herein incorporated by reference.

### BACKGROUND OF THE INVENTION

1. Field of the Invention

The present invention relates to a device and a method for the identification of persons.

2. Discussion of the Background

Security checkpoints are provided wherever it is necessary to monitor persons who are to be granted access to a given security-relevant area. This may relate to checkpoints at airport terminals where flight passengers check-in with their ID-documents before joining a booked flight, or it may relate to security checks, for example, in research centres, banks or industrial enterprises where the identity of employees must be determined. All of these security checkpoints share the common goal of ensuring, on the one hand, that the persons are identified as unambiguously as possible and, on the other hand, that, as far as possible, they do not experience the overall process as unpleasant. Accordingly, the identification process should require only a minimum of time.

A system and a method for comparing faces is already known from EP 1 629 415 B1. In this context, various images of the person to be identified are made by several cameras which are arranged at different angles and which also show profile views as well as front views of the face. Different features are registered in this manner, which are then compared with features in a profile associated with the person to be monitored. The features include, for example, distance measurements between the nose, the ears and other orientation points relative to a nodal point in the facial landscape. The use of laterally arranged cameras allows a three-dimensional image of the face of the person to be investigated, which contains, for example, information on the relief or the depth of the face.

It is disadvantageous with EP 1 629 415 B1 that a person to be investigated can only be correctly recognized if the features necessary for the identification are registered by the camera system. For example, if the person under investigation is wearing a head covering, a face veil or has relatively long hair, which covers a part of the face and/or the ears, this makes the automatic identification of the person more difficult. Furthermore, the features for identification are only features which can be extracted from the visible part of the face. Other features, such as the body size or the shape of the skull are not used for the identification of the person.

### SUMMARY OF THE INVENTION

Accordingly, embodiments of the present invention advantageously provide a method and a person-identification system for the identification of persons, which registers a plurality of biometric features and compares these with stored biometric features, wherein the biometric features can be safely recognized even if these are covered by hair or fabrics.

The method according to the invention for the identification of persons comprises various method steps. In a first step, the person to be identified is placed in a scanner unit, which scans the person to be identified with an electromagnetic radiation, which provides a wavelength in the millimeter range and/or centimeter range. In a second step, the scanner unit generates a multi-dimensional, preferably a three-dimensional, image of body geometries of the person to be identified. In a third step, a three-dimensional image of the person to be identified is stored as test data. In a fourth step, the stored test data are processed and the biometric features necessary for the identification are extracted from these test data. In a fifth step, the extracted biometric features are compared with stored biometric features.

The use of a scanner unit which scans the person with an electromagnetic radiation in the millimeter range and/or centimeter range is particularly advantageous. Accordingly, the electromagnetic radiation is not reflected, for example, from the clothing or the headwear of the person to be identified, but only from the layer of skin disposed beneath. According to the invention, it is therefore possible to generate a very accurate three-dimensional image of the person, so that the biometric features to be extracted are not restricted only to those from the face area. By comparison with known methods, the identification of the person is significantly more accurate and faster, wherein the method according to the invention is a completely contact-free method.

The person-identification system according to the invention provides a scanner unit, which scans a person to be identified by means of electromagnetic radiation, which provides a wavelength in the millimeter range and/or centimeter range. In this context, the person-identification unit according to the invention prepares a three-dimensional image of body geometries of the person to be identified and stores this in a storage unit. Furthermore, the person-identification system provides a processing unit, which processes the stored test data and extracts the biometric features. Moreover, the processing unit compares the extracted biometric features with the biometric features which are stored in at least similarly.

The use of a scanner unit which scans the person with an electromagnetic radiation in the millimeter range and/or centimeter range is particularly advantageous. Accordingly, the electromagnetic radiation is not reflected from the clothing or the headwear of the person to be identified, but only from the layer of skin disposed beneath. According to the invention, it is therefore possible to generate a very accurate three-dimensional image of the person, so that the biometric features to be extracted are not restricted only to those from the face area. The use of a processing unit which extracts the biometric features from the test data and compares them with biometric features which are stored in various storage units is also advantageous.

A further advantage of the invention is that the biometric features extracted can be stored in an identification document or, for example, for statistical purposes, in a databank. As soon as a person has been identified, additional features, such as the body size in given regions, can be stored in the identification document, so that further non-biometric features, which can be used for plausibility comparisons, are available in addition to the biometric features.

A further advantage of the invention is achieved if a camera, especially a video camera and/or photographic camera, is additionally connected to the control unit, wherein video images and/or photographic images are also stored in the test data within the storage unit. Accordingly, different systems can be combined, so that the colour of the skin can also be used for the identification.

Finally, it is advantageous if the processing unit is connected via a local network and/or via the Internet to at least one further databank. The extracted biometric features can accordingly be compared with the biometric features stored in the at least one further databank. Within an organization, a person can therefore enter different security-relevant areas which are spatially remote from one another.

### BRIEF DESCRIPTION OF THE DRAWINGS

By way of example, various exemplary embodiments of the invention are described below with reference to the drawings. The same subject matters provide the same reference numbers. In detail, the corresponding figures in the drawings are as follows:

FIG. 1 shows an overview of the person-identification system according to an embodiment of the invention; and

FIG. 2 shows a flow chart which describes the method according to an embodiment of the invention for the identification of persons.

### DETAILED DESCRIPTION OF EXEMPLARY EMBODIMENTS OF THE INVENTION

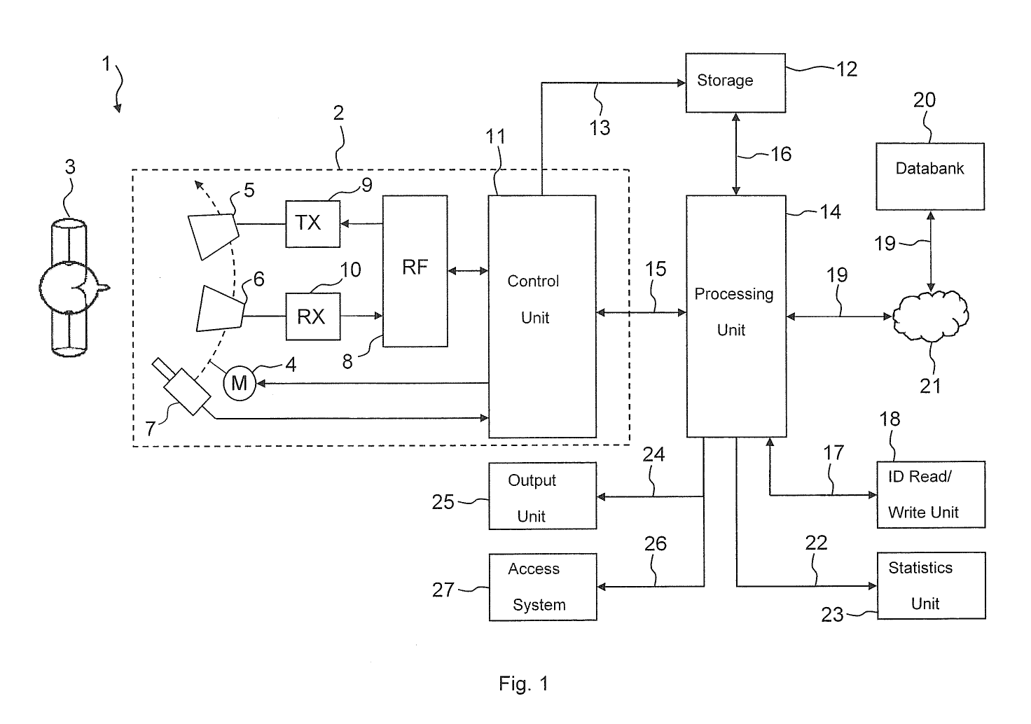

FIG. 1 shows an overview of the person-identification system according to the invention. The person-identification system 1 provides a scanner unit 2 which scans a person to be identified 3 with an electromagnetic radiation with a wavelength in the millimeter range or centimeter range. A signal-recording system comprising a transmission antenna 5, a reception antenna 6 and optionally an optical camera 7 can be displaced around the person to be identified 3 via an electric motor 4, preferably a step motor. The camera 7 is, for example, a video camera and/or photographic camera. By preference, the signal-recording system is displaceable through 360° around the person to be identified 3. This scanning process is preferably implemented in several planes. However, a plurality of antennas can also be arranged distributed in lines or in a matrix format in order to scan the person to be identified 3 in a parallel manner.

A high-frequency unit 8 is connected via the transmitter unit 9 to the transmission antenna 5. At the same time, the high-frequency unit 8 is connected via a receiver unit 10 to the reception antenna 6. The signal received from the high-frequency unit 8 is routed to a control unit 11, which composes image data from the signal received. The control unit 11 also assumes control of the motor 4 and the optical camera 7. If several antennas are arranged distributed in a matrix format, a displacement of the transmission antenna 5 and the reception antenna 6 is not necessary. One antenna respectively always acts in succession as a transmission antenna, and the signal is received by all of the other antennas. The motor 4 for the spatial displacement of the arrangement of antennas 5 and 6 is then not required.

The signal-recording system comprising the transmission antenna 5, the reception antenna 6, the electric motor 4 and optionally the camera 7 and also the transmitter unit 9, the receiver unit 10, the high-frequency unit 8 and the control unit 11 are components of the scanner unit 2. The scanner unit 2 scans the person to be identified 3 with the electromagnetic radiation and generates a three-dimensional image of the person to be identified 3 and then stores this three-dimensional image in the memory unit 12. For this purpose, the control unit 11 is connected to the memory unit 12. This connection 13 is preferably a PCIe-interface (Peripheral Component Interconnect express). The storage unit 12 in the exemplary embodiment is a random access memory in a computer system, or preferably a graphic memory in an image-processing unit.

Moreover, the control unit 11 is connected via the connection 15 to a processing unit 14. This connection 15 is preferably a LAN connection (local area network), by particular preference a PCIe-connection. The processing unit 14 is a computer system. The processing unit 14 controls the scanner unit 2 via this connection 15, and the scanner unit 2 communicates current status information to the processing unit 14. Furthermore, the processing unit 14 reads the test data via the connection 16 from the storage unit 12 and processes this. The processing includes, for example, the selection of a region in which the biometric features might be expected in order to reduce the storage requirement and calculation time.

Following this, the processing unit 14 begins to extract biometric features from the processed test data. The biometric features include, for example, the body size, the ear shape or the ear contours, the shape of the skull, the eye-spacing and spacing distances between various prominent points on the face which are formed primarily by the facial bones. Moreover, the processing unit 14 can search through the test data for anomalies such as body decoration and/or operation scars, and generate biometric features from these in a similar manner. The biometric features can be generated from the test data, which contain, on the one hand, the three-dimensional image of the person to be identified 3 and, on the other hand, video images and/or photographic images from the camera 7.

After the processing unit 14 has extracted the biometric features from the processed test data, these are compared with biometric features which are stored in at least one further storage unit. ID-documents and/or databanks are suitable as the storage unit. For this purpose, various possibilities are available to the processing unit 14. On the one hand, the processing unit 14 is connected via the connection 17 to an ID-document read/write device 18. Via the ID-document read/write device 18, biometric features which are stored, for example, in identification papers, driving licences or passports can be read in.

The ID-document read/write device 18 also allows biometric features which are stored in special access cards or factory identification papers to be read in. Conversely, biometric features can also be copied via the ID read/write device 18 to access cards, which may be required, for example, if a new employee is to be given access to a security-relevant area. In this case, the biometric features extracted from the test data are copied via the ID read/write device 18 to an access card. The ID read/write device 18 can inscribe access cards with magnetic strips and/or RFID chips (radio-frequency identification).

On the other hand, the processing unit 14 can be connected via the connection 19 to various databanks 20. In this context, the connection is made either via the local network and/or via the Internet 21. For connections to databanks 20 which are set up via the Internet 21, encrypted VPN connections (virtual-private network) are preferably used. The databanks 20 can be central databanks of an organization, in which biometric features are stored, so that employees are given access to all sites of the organization worldwide, rapidly and without difficulty. If the person-identification system is installed in public places, such as airports, the extracted biometric features can be compared via the connection 19, for example, with biometric features stored in lists of persons. This is used primarily to find wanted and/or missing persons as rapidly as possible. In this case, video records of the wanted and/or missing persons can also be used for the comparison. It is also possible to store the features extracted from the test data via the connection 19 in the at least one databank 20.

Furthermore, it is possible for the processing unit 14 to store the biometric features extracted from the test data via the connection 22 in a statistics unit 23. These can be used for statistical purposes and correlations, for example, with regard to age and/or sex and/or nationality.

The processing unit 14 is connected via the connection 24 to an output unit 25. The output unit 25 preferably comprises a screen for the output of visual information. If the person 3 is identified, a message is displayed by the output unit 25. If the person is not identified or if the identified person 3 is a wanted and/or missing person 3, an alarm is output and the operating personnel can take further steps. Instead of or in addition to a visual message, the message can also be an acoustic message.

Finally, the processing unit 14 can be connected via the connection 26 to at least one access system 27. If a person 3 is identified, the access system 27 is informed that it should open a given access region for the identified person 3 to a security-relevant region. In the case of airports and industrial organizations, this can be, for example, turnstiles; in banks, for example, gates to safe-deposit rooms.

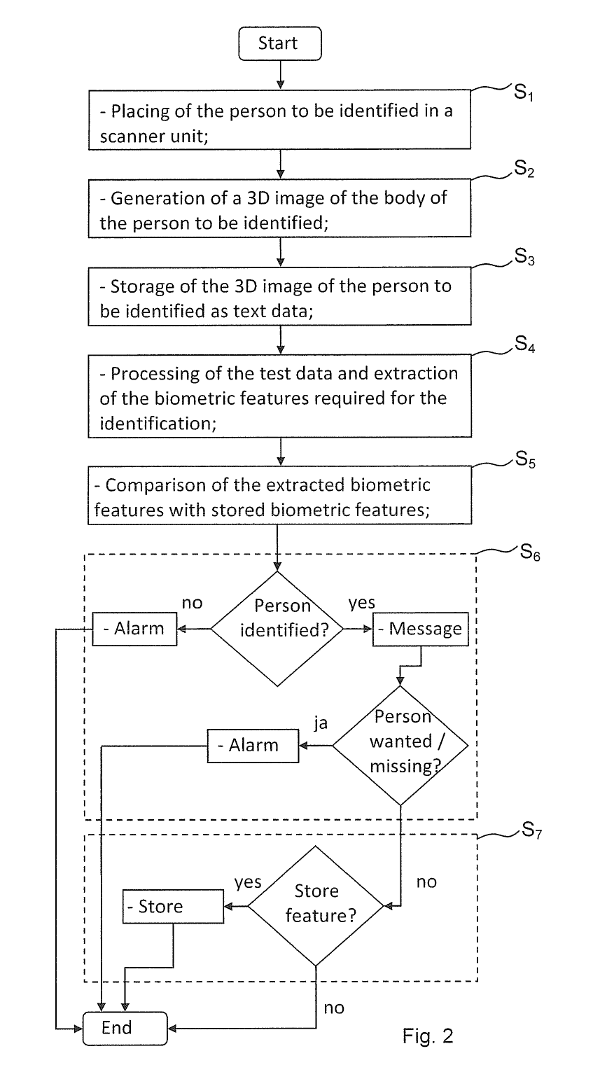

FIG. 2 shows a flow diagram, which describes the method according to the invention for the identification of persons. The method according to the invention for the identification of persons comprises substantially five method steps. Two further method steps are optional in this context. In a first method step S₁, the person to be identified 3 is placed in a scanner unit 2. The scanner unit 2 scans the person to be identified 3 by means of electromagnetic radiation, which preferably provides a wavelength in the millimeter range and/or centimeter range. In this context, the wavelength at the start can be selected in the millimeter range, and the wavelength can then be adjusted to the centimeter range. By preference, the signal-recording system is displaced through 360° around the person to be identified 3.

In a second method step S₂, a three-dimensional image of the body geometry of the person to be identified 3 is provided by the scanner unit 2. In this second method step S₂, image data can optionally be generated by the camera 7, which is also embodied within the scanner unit 2.

In a third method step S₃, the generated three-dimensional image of the person to be identified 3 is stored as test data within a memory unit 12. In this third step, the image data generated by the camera 7 are also stored in the test data.

In the fourth method step S₄, the test data are processed by the processing unit 14. The processing unit 14 finally extracts from the processed test data the biometric features required for the identification of the person 3. In this context, regions such as the face and/or the ears are preferably processed. In this fourth method step S₄, two-dimensional images of the face and/or a lateral view of the head can also be prepared from the test data, from which biometric features can also be extracted. Similarly, the processed test data are investigated for anomalies such as body decoration and/or operation scars. Biometric features are generated in a similar manner from any anomalies found. If the scanner unit 2 comprises a camera 7, these image data are processed within the test data in the fourth method step. Biometric features are then also extracted from the processed image data.

In a fifth method step S₅, a processing unit 14 compares the extracted biometric features with biometric features which are stored in at least one storage unit. For example, the extracted biometric features are compared with the biometric features stored in an identification document. This identification document can comprise ID papers, passports or access cards. Accordingly, the processing unit 14 communicates with an ID-document read/write device 18. It is, of course, also possible to compare the extracted biometric features with biometric features which are disposed in a databank 20 connected to the processing unit 14. For example, lists of wanted and/or missing persons can be stored in this databank 20. These biometric features contain inter alia information on facial features and/or body geometries and/or body size.

Furthermore, the method according to the invention preferably provides a sixth method step S₆. In this method step, an alarm is triggered if the person to be identified 3 cannot be identified or the person 3 is identified, and the identified person 3 is a wanted and/or missing person. In this context, the processing unit 14 communicates with an output unit 25. The output unit 25 outputs the alarm optically and/or acoustically. If the person 3 is identified, a message is output via the output unit 25. This message can also be an optical and/or acoustic output.

In a preferred seventh method step S₇, the extracted biometric features can furthermore be stored in an identification document. This is preferably implemented via the ID-document read/write device 18. Accordingly, identification documents for new employees can be prepared very simply. Similarly, the extracted biometric features can be stored in a statistics unit 23 and also used for statistical purposes and correlations, for example, with regard to age and/or sex and/or nationality.

The invention is not restricted to the exemplary embodiment presented. All of the elements described and/or illustrated can be combined with one another as required within the scope of the invention. The invention is not restricted to such microwave scanners, especially terahertz scanners. Other methods, which supply a corresponding volume of data-records, that is, data according to modulus and phase for each voxel (discrete spatial element), are suitable provided they allow a three-dimensional surface presentation of the human body. X-ray scanners using x-ray radiation are also suitable. In this context, scanners which generate the three-dimensional information only in a secondary manner through corresponding stereo evaluation methods are also included.

1.-22. (canceled)

23. A method for identifying persons which comprises the following method steps:
placing of a person to be identified in a scanner unit with a plurality of antennas which are arranged in a matrix format and form a signal-recording system and scan the person in a parallel manner using an electromagnetic radiation with a wavelength in the millimeter range and/or centimeter range (S₁), wherein the signal-recording system also comprises an optical camera and wherein the signal-recording system is displaceable around the person to be identified;
generating a multi-dimensional, especially three-dimensional, image of body geometries of the person to be identified by the scanner unit (S₂);
storing the generated three-dimensional image of the person to be identified as test data (S₃);
processing of the test data and extraction from the test data of biometric features necessary for the identification (S₄); and
comparing the extracted biometric features with stored biometric features (S₅).

24. The method according to claim 23,
wherein, in the fourth method step (S₄), regions which are suitable for the identification of the person, including the face and/or the ears and/or the shape of the skull, are processed and extracted.

25. The method according to claim 23,
wherein, in the fourth method step (S₄), two-dimensional images of regions, including the face and/or a lateral view of the head of the person to be identified, are prepared.

26. The method according to claim 23,
wherein, in the fourth method step (S₄), the test data are investigated with regard to anomalies, including operation scars, and biometric features are generated from these.

27. The method according to claim 23,
wherein, in the second method step (S₂), additional image data are generated by a camera.

28. The method according to claim 27,
wherein, in the fourth method step (S₄), these image data are also processed, and biometric features are extracted from the processed image data.

29. The method according to claim 23,
wherein, in the fifth method step (S₅), the biometric features are compared with biometric features from at least one identification document.

30. The method according to claim 29,
wherein the biometric features include facial features and/or the body size of the person to be identified.

31. The method according to claim 23,
wherein, in the fifth method step (S₅), the biometric features are compared with biometric features from lists of persons.

32. The method according to claim 23,
wherein the method provides a sixth step (S₆) which comprises the following:
outputting a message if the person is identified; and
triggering of an alarm if a wanted and/or missing person is identified.

33. The method according to claim 23,
wherein the method provides a seventh step (S₇), which comprises the following:
storing biometric features which are used for the identification in an identification document or in a databank;

34. A person-identification system which comprises a scanner unit with a plurality of antennas which are arranged in a matrix format and form a signal-recording system and scan a person to be identified in a parallel manner using an electromagnetic radiation with a wavelength in the millimeter range and/or centimeter range, wherein the signal-recording system also comprises an optical camera and wherein the signal-recording system is displaceable around the person to be identified and prepares a multi-dimensional, especially three-dimensional, image of body geometries of the person to be identified as test data in a storage unit, wherein the person-identification system further provides a processing unit, which processes the test data and extracts the biometric features necessary for the identification and compares these with biometric features which are similarly stored.

35. The person-identification system according to claim 34,
wherein the biometric features are facial contours and/or ear contours and/or a body size.

36. The person-identification system according to claim 34,
wherein the biometric features include a face and/or a lateral view of the head.

37. The person-identification system according to claim 34,
wherein, in the processing unit, the test data are investigated with regard to anomalies, including operation scars, and that the processing unit generates biometric features from these.

38. The person-identification system according to claim 34,
wherein, additionally, a camera is connected to a control unit, and the control unit stores video images and/or photographic images in the test data within the storage unit.

39. The person-identification system according to claim 34,
wherein, via an identification document read/write device, the processing unit compares the biometric features with biometric features which are stored in identification documents.

40. The person-identification system according to claim 34,
wherein the processing unit copies the biometric features via an identification document read/write device to at least one identification document.

41. The person-identification system according to claim 34,
wherein the processing unit is connected via a local network and/or Internet to at least one databank, by which the processing unit compares the biometric features with biometric features of wanted and/or missing persons stored there.

42. The person-identification system according to claim 34,
wherein the processing unit is connected to an output unit which displays a message if a person is identified or which outputs an alarm if the person is not identified or respectively if the person is a missing and/or a wanted person.

43. The person-identification system according to claim 34,
wherein the processing unit is connected to an access system, which releases an access if the person is identified.

44. The person-identification system according to claim 34,
wherein the processing unit is connected to a statistics unit and stores the biometric features in the latter.
